(19) United States
(12) Patent Application Publication
(10) Pub. No.: US 2014/0132046 A1
(43) Pub. Date: May 15, 2014

(54) Vehicle Arm Rest Accessory Device

(71) Applicant: Dennis Driscoll, Lakewood, NJ (US)

(72) Inventor: Dennis Driscoll, Lakewood, NJ (US)

(21) Appl. No.: 14/078,692

(22) Filed: Nov. 13, 2013

Related U.S. Application Data
(60) Provisional application No. 61/726,889, filed on Nov. 15, 2012.

(51) Int. Cl. B60N 2/46; B60N 3/10; B60R 7/04

(52) U.S. Cl. CPC B60N 2/4666; B60R 7/046; B60N 3/103
USPC 297/188.18; 297/411.22

(57) ABSTRACT

A vehicle interior accessory is provided that provides an arm rest securable to the interior surface of a vehicle door, while further providing a location to store articles therein and to mount a beverage holder thereto. The device comprises an elongated housing having an interior volume and a hinged upper surface, wherein the upper surface is preferably padded to provide an arm rest for a vehicle occupant. An elongated flange having a curved upper end secures within the window slot of a vehicle door between the opening and the window itself, wherefrom the housing is supported along the opposite end thereof. The housing can be repositioned along the flange to location the arm rest at the desired height, while the end of the housing provides a connection member for an optional beverage holder attachment. The device is operably deployable and adapted to be supported by traditional vehicle door structures.

### CROSS REFERENCE TO RELATED APPLICATION

This application claims the benefit of U.S. Provisional Application No. 61/726,889 filed on Nov. 15, 2012, entitled “Arm Rest.” The above identified patent application is herein incorporated by reference in its entirety to provide continuity of disclosure.

### BACKGROUND OF THE INVENTION

1. Field of the Invention

The present invention relates to automotive accessory items and vehicle interior accessories. More specifically, the present invention pertains to a door-mounted armrest accessory item that provides space for a user's arm to rest, interior storage space for articles to be placed therein, and a cup holder attachment.

Many people spend a considerable amount of time driving and sitting in a vehicle. Long trips or jobs that require a user to remain in a vehicle for long periods require that a user be comfortable, and further that the interior features of the car are accommodating to the user's needs. Many individuals eat in the car while on the go or store items within the vehicle interior temporarily until a suitable time is found to remove the items or clean the vehicle. Most vehicles include interiors that provide cup holders, arm rests, storage areas, and other comfort or storage features for these purposes. However, not all vehicles are so accommodating.

The present invention relates to a new vehicle accessory item that is adapted to be deployed within the vehicle interior for several purposes. The first of which is to extend a ledge inward from the vehicle door for the user to rest his or her arm while seated in the adjacent seat. Many doors have very high sills or uncomfortable layouts that do not always suit the particular size and shape of the user. By providing a deployable arm rest removably supported by the vehicle door, the user can dictate the most opportune ergonomic position thereof relative to the user's seat position and arm position while driving.

A second primary function of the present invention is item storage and support, wherein the given vehicle may lack sufficient storage compartments or cup holders for a user. Many vehicles include cup holders and storage areas as an afterthought their overall interior design. For those vehicles making long trips or with many loose items, adequately stowing these items or supporting beverages while in the vehicle is very important. The present invention provides an internal storage compartment for supporting loose items therein, while an optional cup holder support is provided from one side of the device to support a beverage from the vehicle door.

Overall, the present invention provides a vehicle interior accessory item that improves comfort for a user by providing an arm rest ledge, while also offering increased storage capacity and a cup holder option while deployed. Vehicle accessory items are quite popular for improving the functionality of vehicles or for personalizing the same. The present invention is contemplated as the former, wherein the device is supported via a flange member that secures within the window track of the vehicle door to suspend the device from the interior surface of the door. The device provides a storage compartment, an optional beverage cup holder, and a comfortable surface upon which a user can rest his or her arm along the interior of the vehicle door.

2. Description of the Prior Art

Devices have been disclosed in the prior art that relate to vehicle interior accessory items. These include devices that have been patented and published in patent application publications, and generally relate to suspended arm rests for vehicle interiors without additional capabilities or functions beyond support a user's elbow or forearm. The following is a list of devices deemed most relevant to the present disclosure, which are herein described for the purposes of highlighting and differentiating the unique aspects of the present invention, and further highlighting the drawbacks existing in the prior art.

One such device in the prior art is U.S. Pat. No. 4,890,878 to Harary, which discloses a vehicular armrest that engages a window opening, wherein a cushioning pad is provided along the upper portion of the device and a movable cushion pad is slidably positioned along a vertical portion of the device. The device therefore provides an upper armrest pad and a lower armrest pad secured by the window opening. The upper armrest pad is positioned along the window sill and the lower armrest pad can be positioned along the vehicle door interior at a lower position with respect to the upper armrest pad. The Harary device, while providing a window opening supported armrest for a vehicle using a flange connection, provides only an armrest portion and no storage or beverage support capacity.

Another device is U.S. Pat. No. 4,592,584 to White, Jr., which discloses a substantially T-shaped device that includes a downwardly extending lip that secures within a window opening. The upper portion of the device provides a platform for an armrest pad, while a support member extends downward therefrom and bears against the interior of the vehicle door such that the upper platform is largely horizontal. The support member is a bowed member wherein its lower extent bears against the door interior surface and its upper extent supports the platform away from the door interior surface. Similar to the Harary device, the White, Jr. does not teach or suggest incorporation of a storage volume or a cup holder attachment in its use as an arm rest accessory.

U.S. Pat. No. 5,320,401 to Ott discloses a vehicle arm rest that is supported by a window opening, wherein the device employs a flexible strap having friction projections to sustain the position of the arm rest once the strap is placed between the vehicle window glass and the adjacent molding. The friction projections bear against the underside of the molding to fix the upper end of the strap thereagainst, wherefrom the opposite end of the strap is draped over the sill and connected to an arm rest frame having an arm rest pad thereon. The Ott device is directed to a simple, yet effective assembly that can easily be deployed within a vehicle interior. However, the Ott device offers no additional capabilities beyond support of a user's elbow or forearm. The present invention contemplates a combination accessory item that offers an arm rest, storage capacity, and support of a beverage from the surface of a vehicle door.

U.S. Pat. No. 4,982,921 to Sanders discloses an automobile window arm rest that includes an armrest pad, a flap portion that is utilized to secure the assembly to a vehicle door, and a storage compartment adjacent to the armrest pad for storage of small items therein. The flap portion projects from the armrest pad and includes a first and second segment, wherein the segments are adapted to hinge with respect to one another to allow the armrest pad and storage compartment to rotate from a suspended position to a position over the door sill. Once on the door sill, a user can rest his or her arm thereon. When in a suspended position, the storage compartment is accessible. The Sanders device is a material pouch that is similar in structure to a pillow pad with an optional storage pouch thereon, wherein a flap is utilized to secure the assembly to the door surface and rotate the same between a suspended and working state. The present invention contemplates a rigid structure having an elongated and padded upper platform, along with a curved flange for engaging the window slot of the vehicle door. The storage compartment of the present invention is observable and accessible by lifting the upper surface of the assembly and does not require rotation of the entire assembly. The static storage volume and beverage holder capacity is neither taught nor suggested by the Sanders disclosure.

U.S. Pat. No. 6,938,862 to Orona discloses a portable elbow support comprising a hanger portion, a support platform, and an elbow receiving portion that is adapted to be suspended from a vehicle door. The elbow receiving portion is rotatably coupled to the support platform and comprises a cavity adapted to receive the elbow portion of a user's arm therein. One embodiment of the Orona device contemplates a storage compartment in addition to the elbow receiving portion along the support platform. This compartment is an upstanding, open volume adapted to receive articles therein, such as cell phones, cigarette packages, and the like. The compartment of the present invention is an elongated compartment that is shrouded by a lid that comprises the arm rest portion. The compartment is much longer, wider, and larger than that of the Orona device, and is provided as a more useable storage area than the smaller, open compartment of Orona.

The present invention is contemplated as a vehicle interior accessory item that provides usable storage capacity while providing a platform for a seated user to rest his or her arm thereagainst. The device secures to the window opening of a vehicle door and is suspended therefrom, while the end of the device provides a connection to an optional beverage holder support. This combination of features are submitted as offering a new type of vehicle accessory whose design elements significantly diverge from those of the prior art. Consequently it is clear that there is a need in the art for an improvement to existing vehicle interior accessory devices. In this regard the instant invention substantially fulfills these needs.

### SUMMARY OF THE INVENTION

In view of the foregoing disadvantages inherent in the known types of vehicle arm rest accessories now present in the prior art, the present invention provides a new vehicle accessory device that can be utilized for providing convenience for the user while driving in a vehicle.

It is therefore an object of the present invention to provide a new and improved vehicle arm rest accessory device that has all of the advantages of the prior art and none of the disadvantages.

It is another object of the present invention to provide a vehicle arm rest accessory device to provide an operably deployable platform upon which an occupant in a vehicle may rest his or her arm thereon, wherein the device is supported along the interior surface of a vehicle door.

Another object of the present invention is to provide a vehicle arm rest accessory device is to provide a storage compartment for loose articles below an arm rest platform supported along the interior surface of a vehicle door.

Yet another object of the present invention is to provide a vehicle arm rest accessory device that includes a curved flange that is adapted to be accepted into a vehicle side window opening along the interior of the window, wherein the flange rests against the door sill and supports an arm rest platform therebelow along the interior surface of the vehicle door.

Another object of the present invention is to provide a vehicle arm rest accessory device that includes an attachment means for a removably attached beverage container support along an end of the arm rest platform.

Another object of the present invention is to provide a vehicle arm rest accessory device that is removably attached to a vehicle interior and may be readily fabricated from materials that permit relative economy that are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the arm rest accessory device of the present invention.

FIG. 2 shows a view of an embodiment of the beverage holder connection member along the end of the device.

FIG. 3 shows an overhead view of the present invention in an open configuration, wherein the interior of the housing is visible when the hinged upper surface is lifted.

FIG. 4 shows the beverage holder attachment suspended from the end of the present invention using a first embodiment of the beverage holder connection member.

FIG. 5 shows the beverage holder attachment suspended from the end of the present invention using a second embodiment of the beverage holder connection member.

FIG. 6 shows a view of the present invention deployed within the interior of a vehicle.

### DETAILED DESCRIPTION OF THE INVENTION

Reference is made herein to the attached drawings. Like reference numerals are used throughout the drawings to depict like or similar elements of the vehicle arm rest accessory device. For the purposes of presenting a brief and clear description of the present invention, the preferred embodiment will be discussed as used for providing a removable arm rest for an occupant of a motor vehicle, while also providing a location to store articles therein and to support beverages therefrom. The figures are intended for representative purposes only and should not be considered to be limiting in any respect.

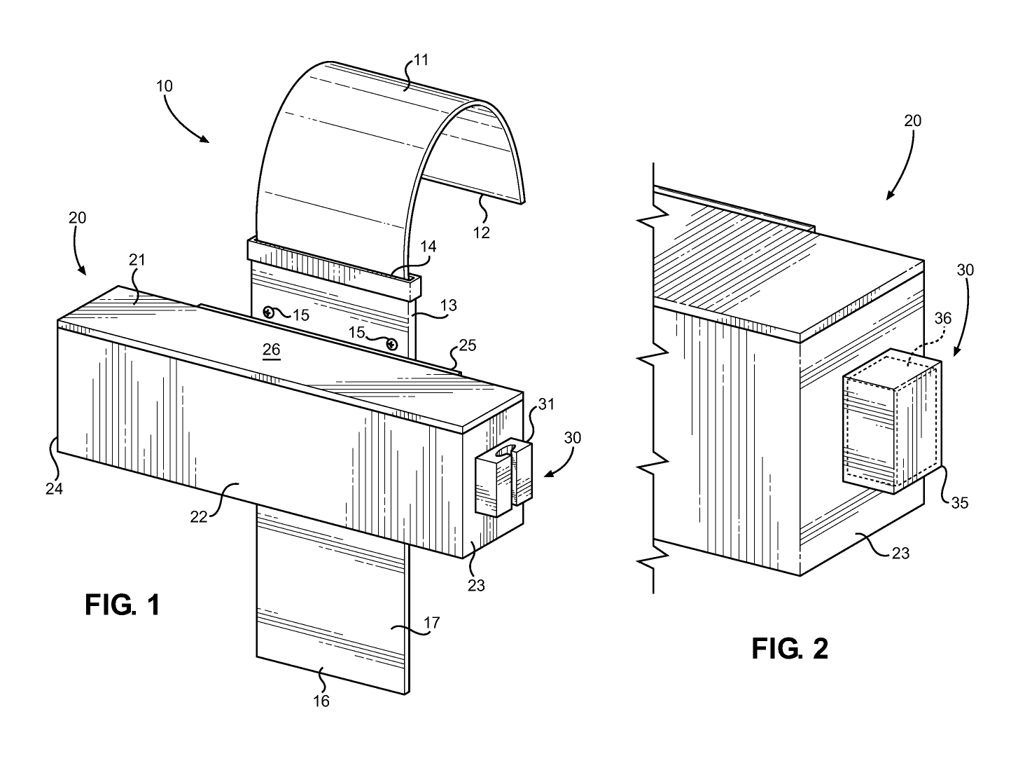

Referring now to FIG. 1, there is shown a perspective view of the vehicle arm rest accessory device of the present invention. The device comprises an arm rest housing 20, a window opening attachment flange 10, and a flange engagement slot 13 along the rear of the housing 20. The device is adapted to be mounted to the window opening of a vehicle door and suspend therefrom, placing an armrest surface 26 at a desired location along the interior surface of the vehicle door as the housing 20 abuts thereagainst.

The attachment flange 10 comprises an elongated flange member having a lower end 16 and a curved upper end 11 that is adapted to form over a vehicle door sill and engage the window opening thereof by inserting the upper flange end 12 therein. The attachment flange 10 is a curved member at its upper extent but is contemplated as taking on several designs. These include a rounded design as shown in FIG. 1, or an angled design that does not include a continuously curving upper. The flange upper extent engages the window opening and positions the arm rest housing 20 along the interior surface of the door, wherein the upper flange end 12 is offset from the housing 20 and offset from the lower end 16 of the flange. The exact shape and design of the flange upper 11 may take on several forms, falling within the scope of engaging a window opening while supporting the housing 20 along its length therebelow and offset from the window opening.

The attachment flange 10 is accepted through a flange engagement slot 13 along the backside of the arm rest housing 20, whereby the housing 20 is slidably positionable along the length of the flange 10 to place the arm rest surface 26 at a comfortable height with respect to the seated vehicle occupant adjacent thereto. The slot 13 includes an open upper end 14 for receiving the flange length 17 therein, wherein the flange 10 is securable in a static position as desired by the user. In one embodiment, the slot opening 14 and the flange having a close-tolerance fitment, wherein the arm rest housing 20 will not slide therealong without concerted effort by the user. Alternatively, the slot 13 can be secured to the flange 10 using set screws or similar fastening members 15 that bear against the flange 10 and prevent relative sliding. When deployed, the housing 20 remains stationary along the flange length 17 such that the user has a defined location upon which to rest his or her arm, and an armrest surface 26 that will not slide downward under the weight of the user's arm.

The arm rest housing 20 comprises an elongated and preferably rectangular structure having an interior volume, an arm rest upper surface 26, a first 24 and second 23 end, an outer surface and an inner surface 22. The exact shape and relationship between sides and ends of the housing 20 may take on different designs, wherein the housing is defined as requiring only an upper arm rest surface 26 and an interior volume. The interior volume of the housing comprises a storage volume for loose articles such that the interior volume is accessible by way of an upper lid 21. The lid 21 is attached to the housing 20 and closed when acting as an arm rest and raised when accessing the housing interior volume. The lid 21 preferably attaches to the housing 20 by way of a hinge joint 25, or alternatively the lid 21 can simply be nested within the upper portion of the housing 20 while deployed.

When the lid 26 is in a closed position, the upper surface 26 provides an area upon which a vehicle occupant can rest his or her arm while seated adjacent thereto. The housing 20 is positioned to the liking of the seated user such that his or her arm can be comfortably supported thereon and the housing 20 interior is accessible when desired. The upper arm rest surface 26 is preferably padded or covered by a comfortable material, wherein the occupant's arm rests with comfort.

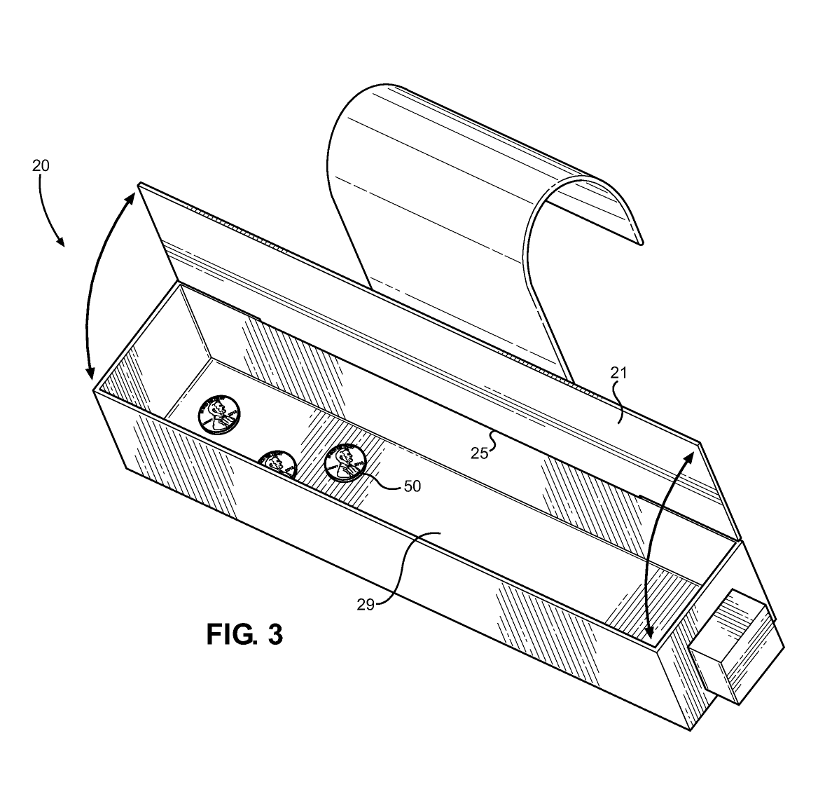

Along one end 23, 24 of the housing 20, there is disposed a connection member 30 for a beverage holder accessory. Referring to FIGS. 1 and 2, the connection member 30 comprises an extension from the housing that provides a means of connection for a beverage holder adapted to be mounted from one end of the device. In a first embodiment and as shown in FIG. 1, the connection member 30 includes a tongue and groove joint connection means 31. The tongue and groove connection means 31 comprises slotted connection whereby a male and female connection member are secured together and the attached beverage holder is statically supported from the end of the housing.

Referring now to FIG. 2, there is shown a second embodiment of the connection member 30 along the end 23 of the housing 20. This embodiment comprises a magnetic translational join, wherein a protruding member 35 having an interior magnet 36 is accepted into a female member along the beverage holder accessory. The magnet 36 of the protruding member 35 is attracted to a magnet within the female member to secure the two portions of the translational joint together. In this embodiment, the beverage holder accessory includes a magnet that is positioned to be attracted to the magnet 36 in the protruding member 35. The male/female connection, along with the magnetic attraction, secures the beverage holder accessory to the end 23 of the housing 20 such that the accessory can support a filled beverage container.

Referring now to FIG. 3, there is shown an overhead view of the vehicle arm rest accessory device of the present invention in an open configuration. In this view, the lid 21 is opened and oriented upward from the housing 20 to reveal the interior volume 29 of the housing. The lid 21 is supported by a hinge 25, or alternatively is supported by a lower portion that nests into the upper opening of the housing 20. Once opened, loose articles 50 can be retrieved or stored within the interior volume 29. This prevents loose articles 50, trash, and other small items from being misplaced in the vehicle interior. This further prevents clutter from accumulating along the floor of the vehicle, wherein the loose articles 50 can be contained within the housing 20 and later retrieved.

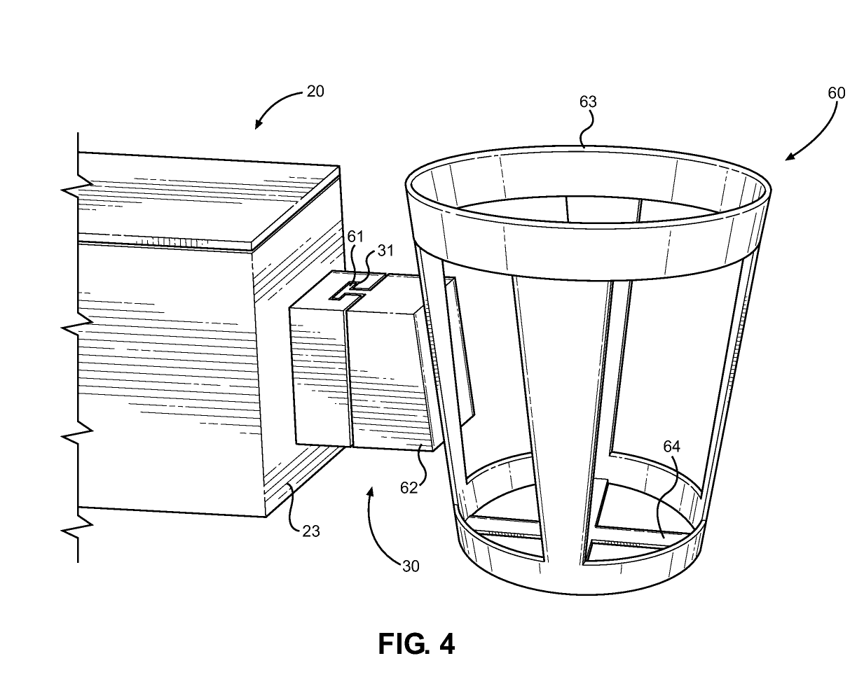

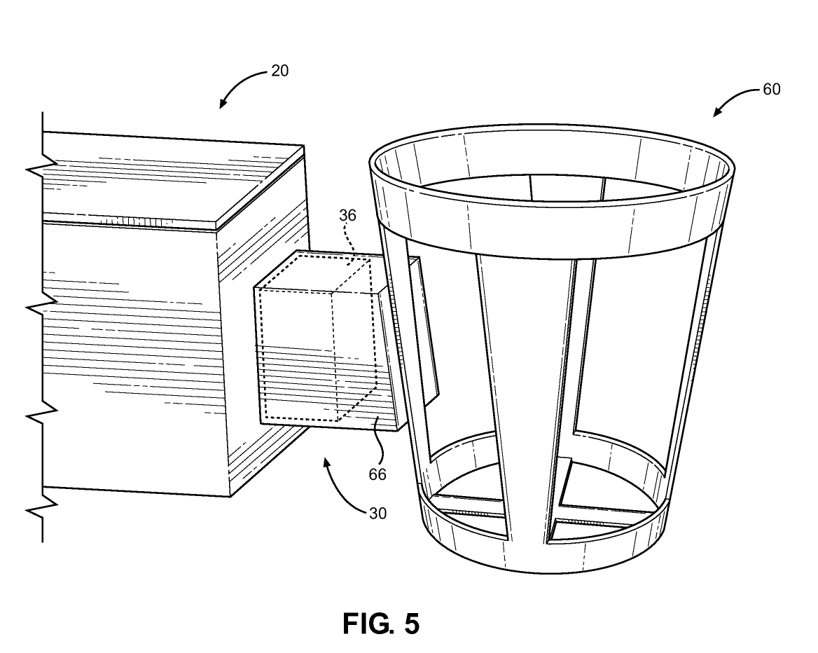

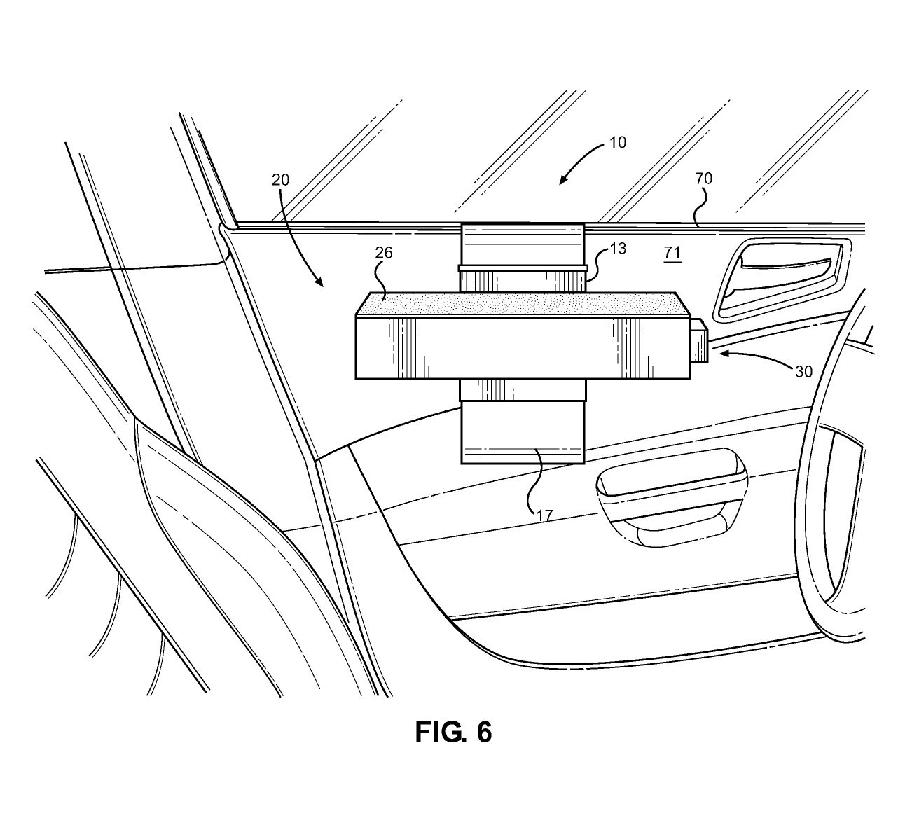

Referring now to FIGS. 4 and 5, there is shown the beverage holder accessory 60 of the present invention, which attaches to the end 23 of the housing 20 and is supported therealong in a cantilevered position. During use, the beverage holder 60 supports filled beverages from the end of the housing for a vehicle occupant. FIG. 4 illustrates the first embodiment of the beverage holder connection member 30, wherein a tongue and groove connection is provided. The housing 20 supports a protruding member 61 with a slot 31 therealong, wherein a tongue extending from a protruding member 62 along the beverage holder 60 makes connection therewith. The two secure to one another and support the holder 60 in a working state such that filled beverages can be supported therein. The preferred embodiment of the beverage holder comprises an open upper 63, supportive sidewalls, and a supportive base for supporting filled and partially filled beverages from the interior surface of the vehicle door.

Referring to FIG. 5, the second embodiment of the beverage holder accessory connection member 30 is shown. In this embodiment, a male magnetic protruding member 36 from the end of the housing 20 is accepted into a female connection member 66 attached to the sidewall of the beverage holder 60. The two engage one another and magnetic attraction is utilized to prevent separation. The protruding member of the housing engages the female connection member 66 sufficiently to accommodate the load imparted thereon by a beverage container placed in the holder 60, wherein the connection remains static while in use and can be separated by a user pulling the two away from one another.

Referring finally to FIG. 6, there is shown a view of the vehicle arm rest accessory device of the present invention. In use, the flange 10 engages the vehicle door window opening and rests over the sill thereof. The housing 20 is supported along the length 17 of the flange and is positioned along the vehicle door interior surface 71 such that the user's arm can be supported thereon. The flange engagement slot 13 accepts the flange therein and prevents sliding of the housing while in use. After attachment to the door, a seated occupant in the vehicle can utilize the upper surface 26 of the housing as an arm rest. The upper surface 26 of the housing 20 may comprise a padded or cushioned arm rest surface, while one end of the device includes a beverage holder accessory connection member 30 for operably supporting a beverage therefrom.

Many people spend a considerable time in their vehicle and find their outer arm grows tired over time. Drivers often attempt to rest their arms on the doorframe, but if the door sill is too high or the vehicle is not sized for the driver, it may be difficult to maintain a comfortable position. People may also find they do not have enough accessible storage places for coins, beverages or other items in the car. This lack of organizational space can lead to clutter, messes, dangerously reaching into the back seat while driving and other problems. The present invention is provided as a new vehicle interior accessory device that provides several functions for vehicle occupants.

The present invention comprises a combination armrest, article storage container, and beverage support device. The device positions an arm rest surface at an occupant's desired height and location along the door interior, while also offering the user a location in which to store loose articles and support beverages therefrom. The device requires no tools to deploy and can be adjusted in position as desired without altering or damaging the vehicle interior. Overall, the present invention provides a new and useful combination vehicle accessory that addresses several issues in the art, wherein the device can be readily deployed and removed as desired by the vehicle owner.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A vehicle arm rest accessory device, comprising:
an elongated arm rest housing having an interior volume, an arm rest upper surface, a first end, a second end, an outer surface, and an inner surface;
said arm rest housing further comprises a lid operably enclosing said interior volume;
a window opening attachment flange adapted to secure over a vehicle door sill, comprising an elongated flange length, a lower end, and an upper end;
said upper end of said window opening attachment flange adapted to be inserted into a window opening of a vehicle door;
an upstanding flange engagement slot disposed along said inner surface of said arm rest housing, said upstanding flange engagement slot adapted to accept said elongated flange length therein;
said upstanding flange engagement slot being slidably positioned along said elongated flange length and securable thereto.

2) The vehicle arm rest accessory device of claim 1, further comprising:
a beverage holder accessory removably attached to an end of said arm rest housing.

3) The vehicle arm rest accessory device of claim 1, further comprising:
a beverage holder connection member extending from an end of said arm rest housing;
a beverage holder accessory having a removable attachment to said connection member.

4) The vehicle arm rest accessory device of claim 3, wherein:
said removable attachment to said connection member comprises a tongue and groove joint.

5) The vehicle arm rest accessory device of claim 3, wherein:
said removable attachment to said connection member comprises male and female magnetic translational joint.

7) The vehicle arm rest accessory device of claim 1, wherein:
said lid is attached to said elongated arm rest housing by way of a hinge joint.

8) The vehicle arm rest accessory device of claim 1, wherein said upstanding flange engagement slot further comprises:
a close-tolerance fitment with respect to said elongated flange length wherein said upstanding flange engagement is adapted to refrain from sliding therealong without user input.

9) The vehicle arm rest accessory device of claim 1, wherein said upstanding flange engagement slot further comprises:
at least one fastener through said upstanding flange engagement slot for securing said elongated flange length therein.

10) The vehicle arm rest accessory device of claim 1, wherein:
said armrest upper surface further comprises a padded surface.

11) The vehicle arm rest accessory device of claim 1, wherein:
said upper end of said window opening attachment flange comprises a curved member.
